(19) United States
(12) Patent Application Publication
(10) Pub. No.: US 2014/0327706 A1
(43) Pub. Date: Nov. 6, 2014

(54) DISPLAY DEVICE AND METHOD FOR ADJUSTING DISPLAY DEVICE

(71) Applicant: Kabushiki Kaisha Toshiba, Minato-ku (JP)

(72) Inventors: Yutaka NAKAI, Kanagawa-ken (JP); Tsuyoshi HIOKI, Tokyo (JP)

(73) Assignee: Kabushiki Kaisha Toshiba, Minato-ku (JP)

(21) Appl. No.: 14/217,676

(22) Filed: Mar. 18, 2014

(30) Foreign Application Priority Data
May 2, 2013 (JP) 2013-097073

(51) Int. Cl. G09G 5/10

(52) U.S. Cl. CPC G09G 5/10
USPC 345/690

(57) ABSTRACT

According to one embodiment, a method is disclosed for adjusting a display device. The device includes light sources, light guides, light extraction units, and a controller. The light guides have an incident portion, one other end portion, and a side surface. The light extraction units form pixels. The controller supplies an electrical signal to the light extraction units to form a light-extracting state and a non light-extracting state. The method can include light intensity acquisition processing, change amount calculation processing, and light intensity modification processing. The acquisition processing acquires first and second intensities of the light. The calculation processing calculates a ratio of a difference between the first and second intensities to a difference between a first previous intensity in the light-extracting state and a second previous intensity in the non light-extracting state. The modification processing reduces the intensity of the light in the light-extracting state.

### CROSS-REFERENCE TO RELATED APPLICATIONS

This application is based upon and claims the benefit of priority from Japanese Patent Application No. 2013-097073, filed on May 2, 2013; the entire contents of which are incorporated herein by reference.

### FIELD

Embodiments described herein relate generally to a display device and a method for adjusting the display device.

### BACKGROUND

A display device that uses a light guide structure has been proposed. The display device includes, for example, multiple light sources arranged in one column, light guides respectively connected to the light sources, and multiple light extraction units opposing surfaces of the light guides. An extraction and a non-extraction of light from the side surfaces of the light guides are controlled by physically or chemically changing the light extraction units. Thereby, the display device displays an image. It is desirable for the display of such a display device to be uniform.

### BRIEF DESCRIPTION OF THE DRAWINGS

FIG. 1 is a schematic plan view showing a display device according to a first embodiment;

FIG. 2 is a schematic cross-sectional view showing the display device according to the first embodiment;

FIG. 3A to FIG. 3D are schematic cross-sectional views showing a portion of the display device according to the first embodiment;

FIG. 4A to FIG. 4D are schematic cross-sectional views showing operations of the display device according to the first embodiment;

FIG. 5 is a flowchart showing the method for adjusting the display device according to the first embodiment;

FIG. 6 is a flowchart showing the method for adjusting the display device according to a second embodiment; and

FIG. 7 is a schematic plan view showing a display device according to a third embodiment.

### DETAILED DESCRIPTION

According to one embodiment, a method is disclosed for adjusting a display device. The device includes a plurality of light sources to emit light, a plurality of light guides, a plurality of light extraction units, and a controller. Each of light guides includes an incident portion, an other end portion provided on a side opposite to the incident portion, and a side surface extending along a first direction from the incident portion toward the other end portion. The light guides are arranged along a second direction intersecting the first direction. The light extraction units are arranged along the first direction to oppose the side surface of each of the light guides. Each of the light extraction units extends along the second direction and is configured to form each of a plurality of pixels at each of a plurality of portions where the light extraction units and the side surface of the light guides oppose each other. The controller is configured to supply an electrical signal to the light extraction units to cause the light extraction units to form a light-extracting state and a non light-extracting state in accordance with the electrical signal. The light propagating through the light guides is extracted from the pixels in the light-extracting state. An intensity of the extracted light in the non light-extracting state is lower than an intensity of the extracted light in the light-extracting state. The method can include performing a first light intensity acquisition processing to acquire a first intensity and a second intensity for at least two pixels of the pixels in a first tone state of emitting the light from the light sources to perform a display having a first brightness and a first color. The first intensity is an intensity of the light propagating to the other end portion when the pixels are in the light-extracting state. The second intensity is an intensity of the light propagating to the other end portion when the pixels are in the non light-extracting state. The at least two pixels include a first pixel and a second pixel. The method can further include performing a first change amount calculation processing to calculate a ratio of a first present absolute value of a difference between the first intensity and the second intensity to a first previous absolute value of a difference between a first previous intensity and a second previous intensity for the at least two pixels in the first tone state. The first previous intensity is an intensity of the light propagating to the other end portion when the pixels are in the light-extracting state. The second previous intensity is an intensity of the light propagating to the other end portion when the pixels are in the non light-extracting state. The first previous intensity and the second previous intensity are acquired prior to the first light intensity acquisition processing. The first change amount calculation processing includes obtaining a first value being the calculated ratio for the first pixel and a second value being the calculated ratio for the second pixel. The method can further include performing a first light intensity modification processing to reduce a modifying intensity in accordance with a ratio of the first value to the second value when the first value is higher than a first threshold and lower than the second value. The first threshold is predetermined. The modifying intensity is an intensity of the light of one of the light sources to cause the light to be incident on the incident portion of one of the light guides corresponding to the second pixel when the second pixel is in the light-extracting state.

According to one embodiment, a display device includes a plurality of light sources to emit light, a plurality of light guides, a plurality of light extraction units, a controller, a light sensor, and a memory unit. Each of light guides includes an incident portion, an other end portion provided on a side opposite to the incident portion, and a side surface extending along a first direction from the incident portion toward the other end portion. The light is incident on the incident portion. The light guides are configured to allow the light to propagate from the incident portion toward the other end portion. The light guides are arranged along a second direction intersecting the first direction. The plurality of light extraction units are arranged along the first direction to oppose the side surface of each of the light guides. Each of the light extraction units extends along the second direction and is configured to form each of a plurality of pixels at each of a plurality of portions where the light extraction units and the side surface of the light guides oppose each other. The controller configured to supply an electrical signal to the light extraction units to cause the light extraction units to form a light-extracting state and a non light-extracting state in accordance with the electrical signal. The light propagating through the light guides is extracted from the pixels in the light-extracting state. An intensity of the extracted light in the non light-extracting state is lower than an intensity of the extracted light in the light-extracting state. The light sensor is configured to sense the intensity of the light reaching the other end portion of the light guides. The memory unit is configured to store a first previous intensity and a second previous intensity in a first tone state of emitting the light from the light sources to perform a display having a first brightness and a first color. The first previous intensity is an intensity of the light propagating to the other end portion when the pixels are in the light-extracting state. The second previous intensity is an intensity of the light propagating to the other end portion when the pixels are in the non light-extracting state. The controller is configured to perform a first light intensity acquisition processing to acquire a first intensity and a second intensity for at least two pixels of the pixels in the first tone state. The first intensity is an intensity of the light propagating to the other end portion when the pixels are in the light-extracting state. The second intensity is an intensity of the light propagating to the other end portion when the pixels are in the non light-extracting state. The at least two pixels include a first pixel and a second pixel. The controller is configured to further perform a first change amount calculation processing to calculate a ratio of a first present absolute value of a difference between the first intensity and the second intensity to a first previous absolute value of a difference between the first previous intensity and a second previous intensity for the at least two pixels in the first tone state, the first previous intensity and the second previous intensity being stored in the memory unit. The first change amount calculation processing includes obtaining a first value being the calculated ratio for the first pixel and a second value being the calculated ratio for the second pixel. The controller is configured to further perform a first light intensity modification processing to reduce a modifying intensity in accordance with a ratio of the first value to the second value when the first value is higher than a first threshold and lower than the second value. The first threshold is predetermined. The modifying intensity is an intensity of the light of one of the light sources to cause the light to be incident on the incident portion of one of the light guides corresponding to the second pixel when the second pixel is in the light-extracting state.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

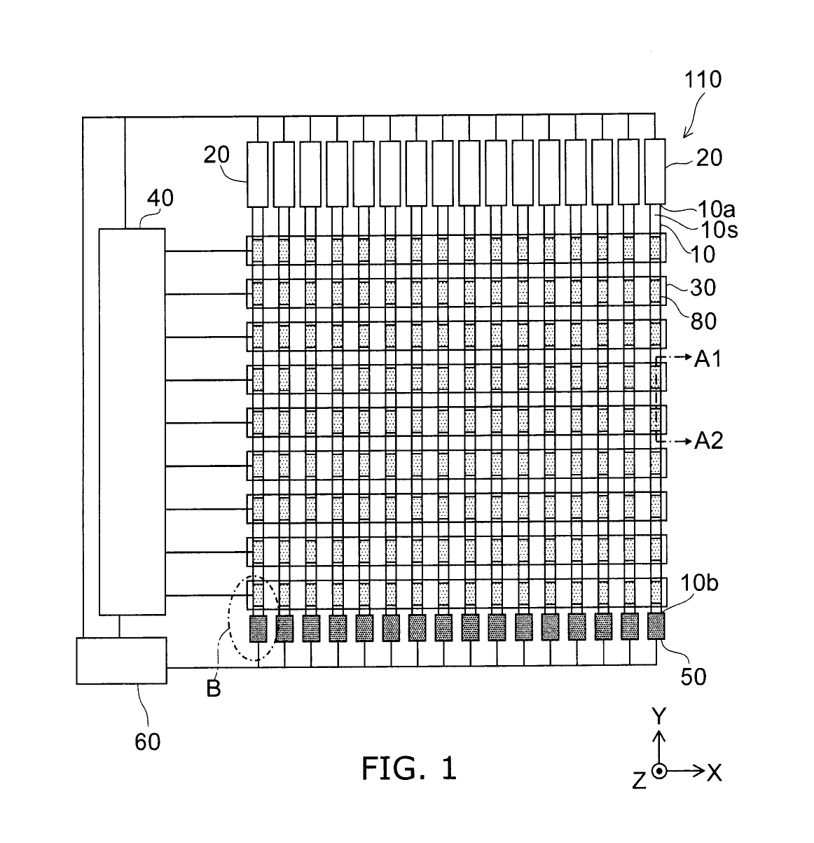

FIG. 1 is a schematic plan view showing a display device according to the first embodiment.

As shown in FIG. 1, the display device 110 according to the embodiment includes multiple light sources 20, multiple light guides 10, multiple light extraction units 30, a controller 40, a light sensor 50, and a memory unit 60.

The multiple light sources 20 emit light. The light sources 20 include light emitting elements such as, for example, LEDs, etc. For the light sources 20, for example, light that is emitted from a light emitting element may be guided; and the light that is guided may be emitted.

Each of the multiple light guides 10 includes an incident portion 10a on which the light emitted from the light source 20 is incident, and one other end portion 10b on the side opposite to the incident portion 10a.

The direction from the incident portion 10a toward the one other end portion 10b is taken as a first direction (e.g., a Y-axis direction). The light guide 10 extends along the first direction. The light guide 10 has a side surface 10s extending in the first direction. The light propagates through the light guide 10 from the incident portion 10a toward the one other end portion 10b. The multiple light guides 10 are arranged along a second direction (e.g., an X-axis direction). The second direction is a direction intersecting the first direction. In the example, the second direction is orthogonal to the first direction.

The light guide 10 includes, for example, a light-transmissive resin such as acrylic, light-transmissive glass, etc. The configuration of the cross section (the cross section when cut by a plane perpendicular to the first direction) of the light guide 10 is, for example, quadrilateral, circular, elliptical, etc. In the embodiment, the configuration of the cross section of the light guide 10 is arbitrary.

Each of the multiple light extraction units 30 extends along the second direction. The multiple light extraction units 30 are arranged along the first direction. Each light extraction unit 30 opposes the side surface 10s of each of the multiple light guides 10. The portions where the light extraction unit 30 oppose the side surfaces 10s of the light guides 10 are used as pixels 80. In the display device 110, multiple pixels 80 are arranged along the first direction and the second direction. In other words, the multiple pixels 80 are formed respectively at the multiple portions where the multiple light extraction units 30 oppose the side surfaces 10s of the multiple light guides 10.

The light extraction unit 30 is capable of an operation of extracting the light that propagates through the light guide 10 from the side surface 10s of the light guide 10 (i.e., the pixel 80). An example of the configuration of the light extraction unit 30 is described below.

The controller 40 supplies an electrical signal to the multiple light extraction units 30. The controller 40 causes the multiple light extraction units 30 to form a light-extracting state and a non light-extracting state according to the electrical signal. The light-extracting state is a state in which the light propagating through the light guide 10 is extracted from the pixel 80. The non light-extracting state is a state in which the intensity of the light extracted from the pixel 80 is lower than that of the light-extracting state. The light-extracting state corresponds to a selected state; and the non light-extracting state corresponds to an unselected state. The intensity of the light emitted from the light source 20 in the light-extracting state corresponds to the brightness of the display (a bright state, a dark state, etc.). The light extraction unit 30 functions as a switch that is capable of switching between the light-extracting state and the non light-extracting state.

The light sensors 50 sense the intensity of the light emitted from the one other end portions 10b of the multiple light guides 10. The light that is emitted from the one other end portion 10b reaches the one other end portion 10b by passing through the light guide 10 without being extracted outside the light guide 10 from the pixels 80. The intensity of the light emitted from the one other end portion 10b includes information relating to the intensity of the light that is not extracted from the pixels 80. The intensity of the light emitted from the one other end portion 10b also includes information relating to the intensity of the light emitted from the light source 20. Accordingly, the intensity of the light emitted from the one other end portion 10b includes information relating to the intensity of the light extracted from the pixel 80. The light sensors 50 include, for example, photodiodes, etc.

The memory unit 60 stores the intensity of the light propagating to the one other end portions 10b of the light guides 10. For example, the memory unit 60 stores the intensity of the light propagating to the one other end portions 10b of the light guides 10 for when the pixels 80 are in the light-extracting state and when the pixels 80 are in the non light-extracting state. Specifically, for example, the memory unit 60 stores the intensity (a first intensity) of the light propagating to the one other end portion 10b for the pixel 80 in the light-extracting state and stores the intensity (a second intensity) of the light propagating to the one other end portion 10b for the pixel in the non light-extracting state for a tone state (e.g., a first tone state) when a prescribed image is performed. The information stored in the memory unit 60 is utilized, for example, in the processing to make the image uniform, i.e., the adjustment processing of the display device, etc., as described below.

In the specification of the application, the intensity of the light propagating to the one other end portion 10b may be a value that is proportional to the intensity of the light at the one other end portion 10b. The proportionality coefficient is, for example, a coefficient determined by a device (e.g., the light sensor 50 described below, etc.) that senses the intensity of the light. The proportionality coefficient may be 1. In other words, the first intensity recited above may be a value that is proportional to the intensity of the light propagating to the one other end portion 10b for the pixel 80 in the light-extracting state. The second intensity recited above may be a value that is proportional to the intensity of the light propagating to the one other end portion 10b for the pixel in the non light-extracting state. The proportionality coefficient of the first intensity is the same as the proportionality coefficient of the second intensity. If a value that is proportional to the intensity of the light propagating to the one other end portion 10b can be obtained, it is unnecessary to sense the light at the one other end portion 10b; and the sensing of the light may be performed at, for example, another position of the light guide 10 (e.g., the incident portion 10a, etc.).

The first tone state includes a state of emitting light for displaying, for example, a prescribed brightness (a first brightness) and a prescribed color (a first color) from the multiple light sources 20.

For example, M light sources 20 and M light guides 10 are arranged along the X-axis direction. On the other hand, N light extraction units 30 are arranged along the Y-axis direction. Thereby, the pixels 80 are formed to be M in the X-axis direction by N in the Y-axis direction. The multiple pixels 80 are disposed two-dimensionally.

One light extraction unit 30 is used as one line. The light extraction unit 30 at one Y-axis direction end is referred to as the first line. The light extraction unit 30 at the other Y-axis direction end is referred to as the Nth line. For example, the light extraction unit 30 is scanned from the first line toward the Nth line by sequentially switching by line. Thereby, as described below, an image can be displayed using the multiple pixels 80.

The image data of the ith (i=1 to N) line is supplied to the light sources 20 to display the ith line. The light sources 20 emit the light of the intensity and color corresponding to the image data of the ith line. The light propagates through the light guide 10 corresponding to each of the light sources 20 along the Y-axis direction.

The controller 40 supplies a drive signal to the ith light extraction unit 30 synchronously with the light. The ith light extraction unit 30 to which the drive signal is provided is switched to the light-extracting state. On the other hand, the light extraction units 30 to which the drive signal is not provided (the light extraction units 30 other than the ith light extraction unit 30) are switched to the non-extracting state.

The light propagating through the light guides 10 (i.e., the light having the intensity and color corresponding to the image data of the ith line) is extracted from the ith light extraction unit 30.

After the operation of the ith line recited above, the image data of the (i+1)th line is supplied to the light sources 20. Then, the controller 40 selects the (i+1)th light extraction unit and supplies the drive signal. Thereby, the light corresponding to the (i+1)th image data is extracted from the (i+1)th light extraction unit 30.

The desired light is extracted by implementing the operation recited above for the first to Nth lines. The desired image is obtained by repeating this operation.

In the example, one pixel 80 is formed at the intersection between one light extraction unit 30 and one light guide 10. In the embodiment, one pixel 80 may be formed of multiple light extraction units 30.

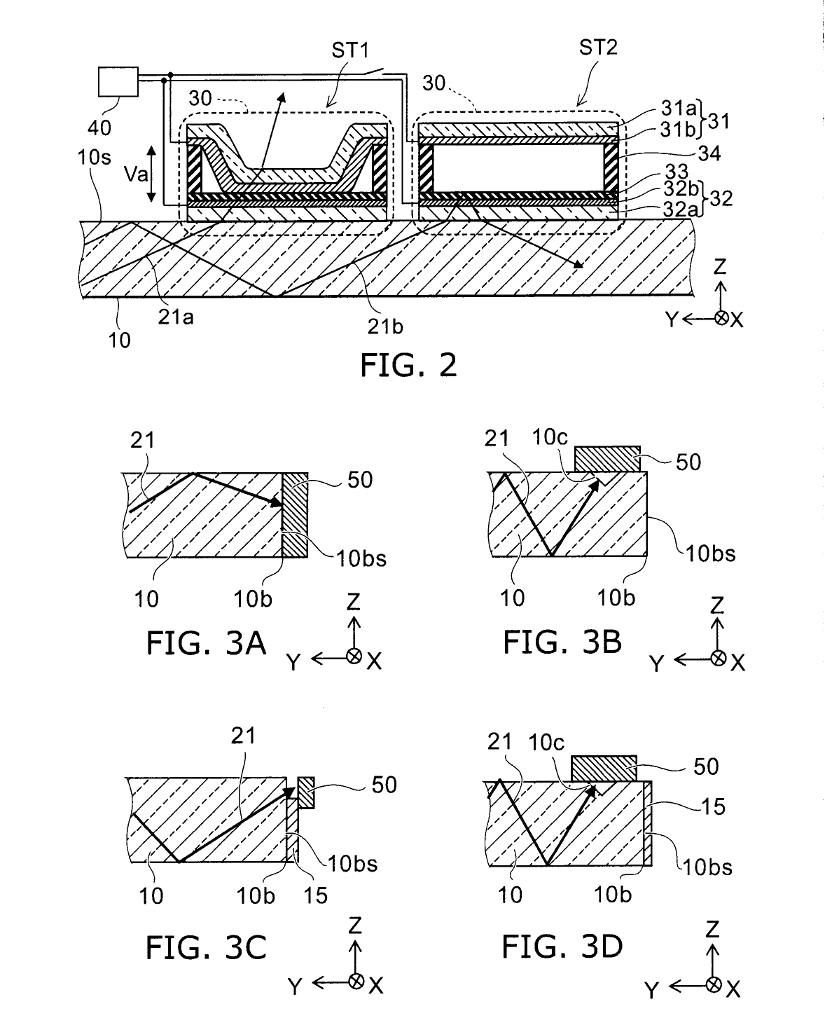

FIG. 2 is a schematic cross-sectional view showing the display device according to the first embodiment.

FIG. 2 is a cross-sectional view along line A1-A2 of FIG. 1.

As shown in FIG. 2, the light extraction unit 30 includes, for example, a first substrate unit 31, a second substrate unit 32, an insulating film 33, and a spacer 34.

The second substrate unit 32 is disposed between the first substrate unit 31 and the light guide 10. The first substrate unit 31 includes a first substrate 31a and a first electrode 31b. The first electrode 31b is provided between the first substrate 31a and the second substrate unit 32. The second substrate unit 32 includes a second substrate 32a and a second electrode 32b. The second electrode 32b is provided between the first substrate unit 31 and the second substrate 32a.

The insulating film 33 is provided between the first electrode 31b and the second electrode 32b. In the example, the insulating film 33 is provided on the second electrode 32b. The spacer 34 separates the first substrate unit 31 from the second substrate unit 32. The first substrate 31a includes, for example, a resin film (e.g., a polyimide film, etc.). The thickness of the first substrate 31a is, for example, about 100 μm. The first electrode 31b includes, for example, a light-transmissive conductive film such as ITO (Indium Tin Oxide), etc. The thickness of the first electrode 31b is, for example, about 100 nm.

The second substrate 32a includes, for example, a light-transmissive substrate. The second electrode 32b also includes a light-transmissive conductive film such as ITO, etc. The thickness of the second electrode 32b is, for example, about 100 nm. For example, a light-transmissive acrylic resin film is provided as the insulating film 33 on the second electrode 32b. The thickness of the insulating film 33 is about 3 μm. A resin layer that is used to form the spacer 34 is formed in a prescribed pattern on the insulating film 33. The spacer 34 is formed of, for example, a photosensitive resin. The thickness of the spacer 34 is about 5 μm.

The first substrate unit 31 is disposed on the second substrate unit 32 with the spacer 34 interposed. For example, the first substrate unit 31 is fixed to the spacer 34 by thermal compression bonding. For example, a micro unevenness (not shown) is provided in the outer surface of the first substrate 31a (the surface on the side opposite to the surface where the first electrode 31b is provided). The micro unevenness increases the light extraction efficiency to the external environment from the first substrate 31a.

The first electrode 31b and the second electrode 32b are electrically connected to the controller 40. The controller 40 controls a voltage Va between the first electrode 31b and the second electrode 32b.

For example, the state in which the voltage is applied corresponds to a light-extracting state ST1. The state in which the voltage is not applied or the applied voltage is low corresponds to a non light-extracting state ST2. According to the configuration of the light extraction unit 30, the state in which the voltage is applied may correspond to the non light-extracting state ST2; and the state in which the voltage is not applied or the applied voltage is low may correspond to the light-extracting state ST1.

In the example, the state in which the voltage is applied corresponds to the light-extracting state ST1; and the state in which the voltage is not applied corresponds to the non light-extracting state ST2. In the state in which the voltage is not applied, light 21b propagates through the light guide 10, passes through the second substrate unit 32, undergoes a total internal reflection at the insulating film 33, and returns to the light guide 10.

When the voltage Va is applied between the first electrode 31b and the second electrode 32b, a portion of the first substrate unit 31 contacts the second electrode 32b with the insulating film 33 interposed due to the electrostatic force between the electrodes. Therefore, at least a portion of light 21a that propagates through the light guide 10 passes through the second substrate unit 32 and the insulating film 33 to reach the first substrate unit 31. Further, the travel direction of the light 21a is changed at the unevenness of the surface of the first substrate 31a; and the light 21a is emitted to the outside.

As recited above, the light extraction from the light guide 10 is switched electrically by the voltage applied to the electrodes. For example, the voltage Va that is applied is about 200 V. In such a case, the switching time between the light-extracting state ST1 and the non light-extracting state ST2 of the light extraction unit 30 is about 100 μs (microseconds); and the light extraction unit 30 has a high-speed response. The display device 110 also can display a video image. For example, there are substantially no operation errors or uneven brightness of the image caused by the signal delays of the light extraction units 30.

FIG. 3A to FIG. 3D are schematic cross-sectional views showing a portion of the display device according to the first embodiment.

These drawings show examples of cross sections when portion B including the one other end portion 10b of the light guide 10 is cut by the Y-Z plane. These drawings show examples of the light sensor 50.

As shown in FIG. 3A, the light sensor 50 is provided to oppose an end surface 10bs of the one other end portion 10b of the light guide 10. The end surface 10bs is a surface intersecting (e.g., perpendicular to) the first direction (e.g., the Y-axis direction) of the light guide 10. The end surface 10bs may be tilted with respect to the first direction. In the example, the light sensor 50 is provided as an extension of the light guide 10 along the first direction.

As shown in FIG. 3B, the light sensor 50 is provided to oppose the side surface 10s at the one other end portion 10b of the light guide 10. In the example, a recess 10c (e.g., a notch) is provided in the side surface 10s at the one other end portion 10b of the light guide 10. The light sensor 50 is provided to oppose the recess 10c.

As shown in FIG. 3C, the light sensor 50 is provided to oppose a portion of the end surface 10bs of the one other end portion 10b of the light guide 10. A reflective layer 15 is provided to oppose another portion of the end surface 10bs.

As shown in FIG. 3D, the light sensor 50 is provided to oppose the recess 10c provided in the side surface 10s at the one other end portion 10b of the light guide 10. The reflective layer 15 is provided to oppose the end surface 10bs of the one other end portion 10b of the light guide 10.

For example, the utilization efficiency of the light can be increased by providing the reflective layer 15.

In all of the cases shown in FIG. 3A to FIG. 3D, the light sensor 50 can sense the intensity of the light that propagates through the light guide 10 to reach the one other end portion 10b. The light sensor 50 is provided at any position where the intensity of the light propagating to the one other end portion 10b of the light guide 10 can be sensed. The intensity that is sensed by the light sensor 50 may be an intensity that is proportional to the intensity of the light that reaches the one other end portion 10b. In such a case, the proportionality coefficient may be a predetermined value and may be 1.

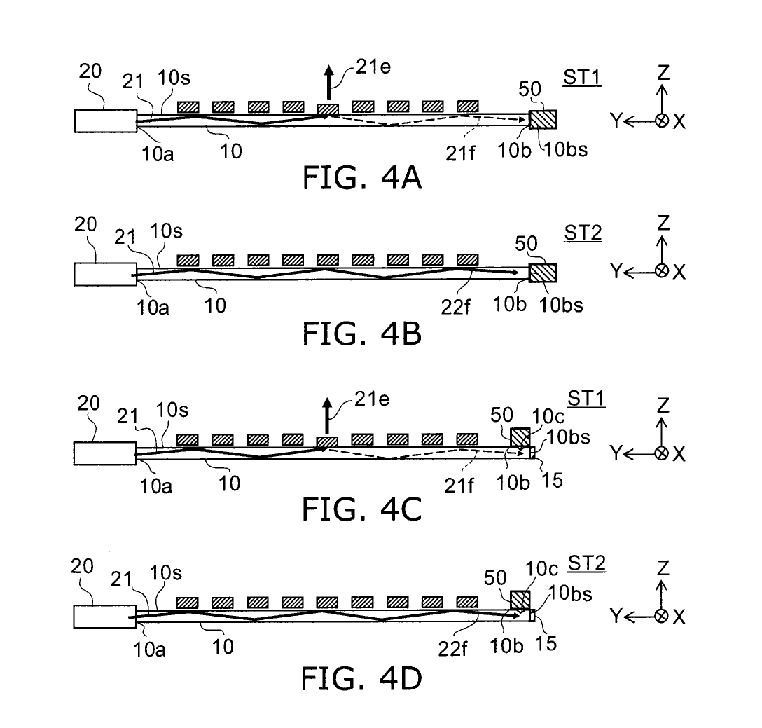

FIG. 4A to FIG. 4D are schematic cross-sectional views showing operations of the display device according to the first embodiment.

These drawings show examples of the cross section when cut by the Y-Z plane.

In FIG. 4A and FIG. 4B, the light sensor 50 is provided to oppose the end surface 10bs of the one other end portion 10b of the light guide 10. In FIG. 4C and FIG. 4D, the light sensor 50 opposes the recess 10c provided in the side surface 10s at the one other end portion 10b of the light guide 10.

FIG. 4A and FIG. 4C correspond to the case where one of the light extraction units 30 is in the light-extracting state ST1. FIG. 4B and FIG. 4D correspond to the case where the light extraction units 30 are in the non light-extracting state ST2.

As shown in FIG. 4A and FIG. 4C, light 21 that is emitted from the light source 20 propagates through the light guide 10 toward the one other end portion 10b. Light 21e is extracted from the light extraction unit 30 in the light-extracting state ST1. At this time, light 21f which is the light 21 other than the light 21e extracted by the light extraction unit 30 reaches the one other end portion 10b. The light sensor 50 senses the light 21f.

In the case when the light extraction units 30 are in the non light-extracting state ST2 as shown in FIG. 4B and FIG. 4D, the light 21 propagates as-is through the light guide 10; and light 22f reaches the one other end portion 10b as-is. The light sensor 50 senses the light 22f.

Thus, when the light extraction unit 30 is in the light-extracting state ST1, a portion of the light 21 is extracted outside the light guide 10 from the light extraction unit 30; and the remaining portion of the light 21 propagates through the light guide 10 to be incident on the light sensor 50 at the one other end portion 10b.

Accordingly, the difference between the light intensity at the one other end portion 10b when the light extraction unit 30 is in the light-extracting state ST1 and the light intensity at the one other end portion 10b when the light extraction unit 30 is in the non light-extracting state ST2 is a value that is proportional to the light intensity extracted from the light extraction unit 30. The light intensity extracted from the light extraction unit 30 corresponds to the brightness of the image.

Accordingly, by monitoring the value of the difference recited above, the intensity of the extracted light can be monitored, that is, an amount that is proportional to the brightness for each pixel can be monitored. This property is characteristic to the display device that uses the light guides 10 and the light extraction units 30.

There are cases where the image becomes nonuniform in such a display device 110. For example, there are cases where the image of on display becomes nonuniform due to the fluctuation of the characteristics of the multiple light sources 20, the fluctuation of the characteristics of the multiple light guides 10, and the fluctuation of the characteristics of the multiple light extraction units 30. Further, there are cases where the image on the display becomes nonuniform due to the fluctuation when assembling these parts. For these reasons, for example, there are cases where the brightness is different between the pixels 80.

The image on the display can be made uniform by performing a correction of the nonuniformity of the image on the display caused by such fluctuation to make the brightness uniform for the pixels 80 after assembling the display device.

However, it was found that the uniformity of the image degrades when the operation time of the display device becomes long.

One cause of the degradation of the uniformity of the image is that the degree of the degradation of the characteristics of the parts is different between the multiple parts. For example, there is a tendency for the performance of the light source 20 or the light extraction unit 30 to degrade. For example, in the case where an LED, etc., is used as the light source 20, the characteristics degrade when used over a long period of time. For such performance degradation, the difference between the multiple parts (e.g., the multiple light sources 20) is large.

Another cause of the degradation of the uniformity of the image is that the operating conditions of the parts (the light sources 20, etc.) are different between the display locations according to the display image. For example, according to the display image, there are cases where the operating conditions of the parts (the light sources 20, etc.) corresponding to designated display locations are more extreme than the operating conditions of the parts corresponding to other display locations. For these reasons, a state occurs in which the degree of the degradation is different between the multiple parts (e.g., the light sources 20).

Thus, the uniformity of the image (the uniformity of the brightness of the pixels 80) degrades due to the change over time, the difference of the characteristics occurring for the multiple parts, the difference of the operating conditions for the multiple parts that is dependent on the display image, etc.

Thus, in the display device 110 in which the multiple parts (the multiple light sources 20, the multiple light extraction units 30, and the multiple light guides 10) are combined, it was found that the image becomes nonuniform due to the difference of the change of the characteristics between the multiple parts when used for a long period of time. It is important to perform a uniform image by reducing the nonuniformity of the image that occurs due to such a change over time.

The nonuniformity of the initial image directly after manufacturing the display device can be made uniform by adjusting the characteristics in the factory. However, as recited above, it is difficult to correct the nonuniformity of the image that occurs as the time of use lengthens by an adjustment such as that implemented in the factory.

In the embodiment, a uniform image is possible by improving the nonuniformity of the image occurring during such use. For example, a method for increasing the uniformity of the display (a method for correcting the image unevenness) is a method for adjusting the display device. An example of the operation of the display device 110 will now be described.

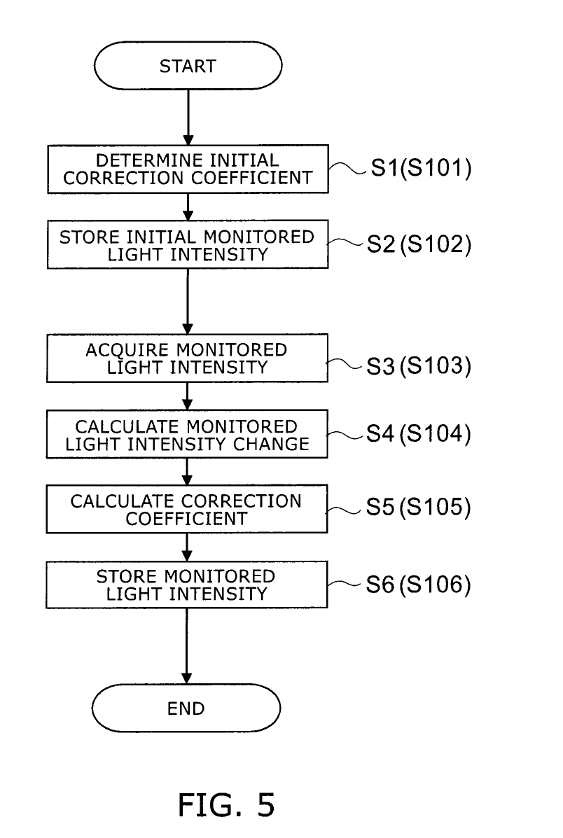

FIG. 5 is a flowchart showing the method for adjusting the display device according to the first embodiment.

First, in initial correction coefficient determination processing (step S1), the correction coefficient (the initial correction coefficient) is determined for each of the pixels 80.

For example, the display device 110 is set to a state in which light of a designated tone is to be emitted from each of the pixels 80. For example, a predetermined signal (a signal to display the prescribed tone) is supplied to the light sources 20. Then, the light extraction units 30 are switched to the light-extracting state. At this time, the intensity of the light 21 emitted from each of the multiple light sources 20 is not always uniform due to the fluctuation of the multiple light sources 20. Moreover, the intensity of the light 21e emitted from the pixels is not always uniform due to the fluctuation of the characteristics of the light extraction units 30.

The state is set to be the state in which the light of the designated tone is to be emitted from each of the pixels 80; and the brightness is measured for each of the pixels 80 in this state. For example, the image may be measured (or captured) by an imaging device (a digital camera, etc.). The brightness is quantified for each of the pixels 80. When measuring the brightness of each of the pixels 80, all of the light extraction units 30 may be in the light-extracting state ST1; or the multiple light extraction units 30 may be switched to the light-extracting state ST1 sequentially. The brightness of all of the pixels 80 may be measured together at once; or the brightness may be measured in order for each of the pixels 80.

The correction coefficient (the initial correction coefficient) is determined for each of the pixels 80 based on the brightness of each of the pixels 80 that is measured. For example, the correction coefficients match the brightness of the darkest pixel 80 of all of the pixels 80 by reducing the brightness of the light sources 20 for the other pixels 80 by the proportions determined for the pixels 80. For example, the correction coefficients of the pixels 80 other than the darkest pixel 80 are the ratios of the brightness of the darkest pixel 80 to the brightness of the other pixels 80. For example, the brightness after the correction is the brightness prior to the correction multiplied by the correction coefficient for each of the light sources 20. Thereby, the brightness can be substantially the same between the pixels 80; and the image on the display can be made uniform.

In initial monitored light intensity storage processing (step S2) in the state recited above in which the correction coefficients are determined, the intensity of the monitored light (the light 21f) in the light-extracting state ST1 and the intensity of the monitored light (the light 22f) in the non light-extracting state ST2 are stored for, for example, all of the pixels 80 using the light sensor 50. The difference between the intensities of the two lights is an amount that is proportional to the brightness after the correction.

The processing to make the image uniform in the initial state of the display device is performed by steps S1 and S2 recited above. The processing may be performed, for example, prior to the shipment of the display device from the factory. Or, the processing may be performed in the initial state when the user starts to use the display device.

The processing recited below corrects the nonuniformity of the image occurring due to the fluctuation of the light sources 20, etc., due to the change over time after the display operates for a long period of time.

For example, in monitored light intensity acquisition processing (step S3), the intensity of the monitored light (the light 21f) in the light-extracting state ST1 and the intensity of the monitored light (the light 22f) in the non light-extracting state ST2 are measured, for example, for all of the pixels 80.

In monitored light intensity change calculation processing (step S4), the ratio of the difference between the monitored light intensities obtained in step S3 after the display operation to the difference between the monitored light intensities obtained in step S2 in the initial state is determined. This value is the proportion of the decrease of the light extracted from the pixel 80 from the initial state (the state of step S2) to the state after the display operation (the state of step S3).

In correction coefficient calculation processing (step S5), for example, the value of the minimum value of the ratio of the difference between the monitored light intensities for all of the pixels 80 obtained in step S4 divided by the difference between the monitored light intensities for each of the pixels 80 is determined. Then, new correction coefficients are obtained by multiplying these values respectively by the correction coefficients (the initial correction coefficients) determined for the pixels 80 for the light sources 20 set in the initial correction.

In other words, the light acquisition amount (the brightness) for each of the pixels 80 decreases due to the change over time. At this time, the brightness of the pixel 80 that decreased the most is matched by reducing the brightness for the other pixels 80. Thus, the image on the display can be made uniform by correcting the correction coefficients.

In monitored light intensity storage processing (step S6), for example, the monitored light intensities determined for the pixels 80 are stored in the memory unit 60.

In the case where the correction is performed again, step S3 to step S6 recited above are performed. At this time, steps S4 and S5 are implemented using, for example, the monitored light intensity determined in the previously-implemented step S6 as the light amount of the monitored light in step S2.

Due to changes over time, for example, there are cases where the light source 20 or the light extraction unit 30 no longer operates. In such a case, the intensity of the light extracted from the pixels 80 decreases radically. In such a case, the minimum value of the ratio of the difference between the monitored light intensities becomes markedly small in step S5. At this time, the entire image undesirably becomes radically dark if the brightness of the other pixels 80 is caused to match the brightness of the pixel 80 of the minimum value.

Therefore, in the case where a radical decrease of the light extraction occurs as recited above, that is, in the case where the minimum value of the ratio of the difference between the monitored light intensities has reached a predetermined value (a threshold) or less, the pixel 80 is considered to be defective and may be excluded from the correction processing to make the image uniform (step S5). Thereby, the image can be made uniform without reducing the brightness of the entire image.

The correction processing recited above (step S3 to step S6) is performed, for example, at a constant interval. The correction processing recited above may be implemented at an indefinite interval. By implementing the correction, the fluctuation of the brightness of the pixels in the image due to the change over time can be suppressed.

The correction processing recited above (steps S3 to S6) is implemented, for example, at a prescribed time interval (e.g., every 100 hours). The correction processing may be implemented, for example, when the power supply is switched ON and the display operation is started. The correction processing may be implemented when the power supply is switched OFF and the display operation ends.

For example, the display device 110 has a display period in which an image display operation is performed using the multiple pixels 80. The correction processing recited above (step S3 to step S6) may be implemented in a period that is different from the display period.

Because the time to implement the correction processing is short, the correction processing substantially does not affect the display. At least a portion of the correction processing may be implemented while implementing the display operation. For example, at least a portion of the correction processing recited above may be implemented for at least a portion of the multiple pixels 80 within the frame period of the display operation.

For example, the difference between the monitored light intensities sensed by the light sensor 50 may be adjusted to be small by the initial adjustment (e.g., there is substantially no difference). Therefore, in the initial state, the difference between the monitored light intensities sensed by the light sensor 50 is small. In other words, the image unevenness is small. Due to the change over time, the difference enlarges, that is, the unevenness of the brightness becomes large. The unevenness of the brightness is reduced by the correction recited above.

In the correction processing recited above, the difference between the monitored light intensities sensed by the light sensor 50 is reduced similarly to the state after the correction processing (including the initial adjustment) performed before changing over time. The proportion of the light that is extracted may be different between the light guides 10.

In the embodiment, at least a portion of the correction processing (the processing to make the image uniform) may be performed for a portion of the multiple pixels 80.

For example, first light intensity acquisition processing (step S103) recited below is performed in the first tone state of emitting the light 21 for displaying the first brightness and the first color from the multiple light sources 20 (referring to FIG. 5). Step S103 corresponds to, for example, at least a portion of step S3. For example, in the first light intensity acquisition processing (step S103), the first intensity of the light (the light 21f) propagating to the other end portion 10b of the light guide 10 when the pixel 80 is in the light-extracting state ST1 and the second intensity of the light (the light 22f) propagating to the one other end portion 10b when the pixel 80 is in the non light-extracting state ST2 are acquired for at least two pixels of the multiple pixels 80.

In such a case, a first previous intensity of the light (the light 21f) propagating to the one other end portion 10b of the light guide 10 when the pixel 80 is in the light-extracting state ST1 and a second previous intensity of the light (the light 22f) propagating to the one other end portion 10b when the pixel 80 is in the non light-extracting state ST2 have been acquired in the first tone state prior to the first light intensity acquisition processing (step S103). These values are stored, for example, in the memory unit 60. The information relating to these values may be stored in a memory unit provided separately from the display device 110.

The first previous intensity recited above is a value that is proportional to the intensity of the light propagating to the one other end portion 10b when the pixel 80 is in the light-extracting state ST1. The second previous intensity recited above is a value that is proportional to the intensity of the light propagating to the one other end portion 10b when the pixel 80 is in the non light-extracting state ST2. The proportionality coefficient of the first previous intensity is the same as the proportionality coefficient of the second previous intensity. The proportionality coefficient may be 1.

After the first light intensity acquisition processing, the first change amount calculation processing (step S104) recited below is performed. Step S104 corresponds to, for example, at least a portion of step S4. In the first change amount calculation processing (step S104), the ratio of the absolute value of the difference between the first intensity and the second intensity to the absolute value of the difference between the first previous intensity and the second previous intensity acquired prior to the first light intensity acquisition processing is calculated for the at least two pixels recited above.

After the first change amount calculation processing, the first light intensity modification processing (step S105) recited below is performed. Step S105 corresponds to, for example, at least a portion of step S5. For example, in the first light intensity modification processing (step S105), the modification of the light intensity is performed when a first value which is the ratio calculated for a first pixel of the at least two pixels 80 is higher than a predetermined first threshold and lower than a second value which is the ratio calculated for a second pixel of the at least two pixels 80. For example, the first pixel is the darkest pixel of the multiple pixels 80. For example, the first pixel is the pixel of the multiple pixels 80 for which the degradation has progressed the most. However, the brightness of the first pixel is higher than the predetermined first threshold; and the first pixel is not determined to be a defective pixel. The second pixel is brighter than the first pixel. At this time, in the first light intensity modification processing, the intensity of the light 21 of the light source 20 that causes the light 21 to be incident on the incident portion 10a of the light guide 10 of the multiple light guides 10 corresponding to the second pixel when the second pixel is in the light-extracting state ST1 is reduced according to the ratio of the first value to the second value.

For example, the ratio of the first value calculated for the first pixel to the second value calculated for the second pixel is used as the correction coefficient of the second pixel. The intensity of the light 21 of the light source 20 corresponding to the second pixel after the correction is set to be the value prior to the correction multiplied by the correction coefficient.

Thereby, a method for adjusting the display device in which a uniform image is possible can be provided.

For example, the correction coefficient may not completely match the ratio of the first value to the second value. For example, the correction coefficient may be a value that corresponds to the ratio of the first value to the second value. For example, the correction coefficient may be the ratio of the first value to the second value multiplied by a prescribed coefficient. In the embodiment, the correction coefficient is determined to make the image uniform.

For example, in the first light intensity modification processing (step S105), the intensity of the light 21 of the light source 20 that causes the light 21 to be incident on the incident portion 10a of the light guide 10 corresponding to the second pixel when the second pixel is in the light-extracting state ST1 after implementing the first light intensity modification processing is caused to approach the value of the intensity of the light of the light source 20 prior to implementing the first light intensity modification processing multiplied by the ratio of the first value to the second value.

For example, the following is performed in the first light intensity modification processing.

A first light intensity is taken to be the intensity of the light 21 of the light source 20 that causes the light 21 to be incident on the incident portion 10a of the light guide 10 corresponding to the second pixel when the second pixel is in the light-extracting state ST1 after implementing the first light intensity modification processing.

A second light intensity is taken to be the value of the ratio of the first value to the second value recited above multiplied by the intensity of the light 21 of the light source 20 that causes the light 21 to be incident on the incident portion 10a of the light guide 10 corresponding to the second pixel when the second pixel is in the light-extracting state ST1 prior to implementing the first light intensity modification processing. This value is, for example, the target value of the correction.

A third light intensity is taken to be the intensity of the light 21 of the light source 20 that causes the light 21 to be incident on the incident portion 10a of the light guide 10 corresponding to the second pixel when the second pixel is in the light-extracting state ST1 prior to implementing the first light intensity modification processing.

In the first light intensity modification processing, the absolute value of the difference between the first light intensity and the second light intensity (the target value) is caused to be less than the absolute value of the difference between the third light intensity and the second light intensity (the target value). In other words, the first light intensity after the first light intensity modification processing is, for example, closer to the target value (the second light intensity) recited above than prior to the processing.

Thereby, the image can be made uniform. For example, the image unevenness due to the change over time is reduced.

For example, the first light intensity modification processing may cause the intensity of the light 21 of the light source 20 that causes the light 21 to be incident on the incident portion 10a of the light guide 10 corresponding to the second pixel when the second pixel is in the light-extracting state ST1 after implementing the first light intensity modification processing to be the value of the ratio of the first value to the second value multiplied by the intensity of the light 21 of the light source 20 prior to implementing the first light intensity modification processing.

Thus, in the embodiment, it is sufficient to implement one processing of making the image uniform for at least two of the multiple pixels 80. For example, the correction processing may be performed for the odd pixels 80 of the multiple pixels 80; and the correction processing may be performed for the even pixels 80 at another time. For example, the frequency at which the correction processing is performed may be different between the multiple pixels 80. For example, the frequency of the correction processing for the peripheral portion of the image may be lower than the frequency of the correction processing for the central portion of the image.

For example, at least a portion of the first light intensity acquisition processing, the first change amount calculation processing, and the first light intensity modification processing recited above may be implemented in a period that is different from the display period. For example, at least a portion of the first light intensity acquisition processing, the first change amount calculation processing, and the first light intensity modification processing recited above may be implemented for at least a portion of the multiple pixels 80 within the frame period of the display operation.

In the embodiment, first post-modification light intensity storage processing (step S106) may be further implemented (referring to FIG. 5). Step S106 corresponds to, for example, at least a portion of step S6. In the first post-modification light intensity storage processing (step S106), for example, the intensity of the light 21 of the light source 20 that causes the light 21 to be incident on the incident portion 10a of the light guide 10 corresponding to the second pixel when the second pixel is in the light-extracting state ST1 that was reduced in the first light intensity modification processing (step S105) is stored. In the first post-modification light intensity storage processing (step S106), for example, the intensity of the light 21 of the light source 20 that causes the light 21 to be incident on the incident portion 10a of the light guide 10 corresponding to the second pixel when the second pixel is in the non light-extracting state ST2 that was reduced in the first light intensity modification processing (step S105) is stored.

For example, the first previous intensity and the second previous intensity are replaced with these stored values, respectively. The corrected value substitution processing can be implemented in, for example, step S5 described above. In the corrected value substitution processing, for example, the first previous intensity recited above is replaced with the intensity of the light 21 of the light source 20 that causes the light 21 to be incident on the incident portion 10a of the light guide 10 corresponding to the second pixel when the second pixel is in the light-extracting state ST1 after the first light intensity modification processing. Also, in the corrected value substitution processing, the second previous intensity is replaced with the intensity of the light 21 of the light source 20 that causes the light 21 to be incident on the incident portion 10a of the light guide 10 corresponding to the second pixel when the second pixel is in the non light-extracting state ST2 after the first light intensity modification processing.

In such corrected value substitution processing, step S103 to step S105 may be further implemented using the new first previous intensity and the new second previous intensity that are substituted.

The method for adjusting the display device according to the embodiment may further include initial adjustment processing. For example, as shown in FIG. 5, first initial light intensity acquisition processing (step S101) that acquires the first previous intensity and the second previous intensity recited above is further implemented. Step S101 corresponds to, for example, at least a portion of step S1.

Further, the first initial light intensity modification processing (step S102) recited below is implemented. In step S102, the processing recited below is performed for one pixel 80 of the multiple pixels 80 and for one other pixel 80 of the multiple pixels 80 that is different from the one pixel 80. For the one pixel 80, the difference between the first previous intensity and the second previous intensity acquired in the first initial light intensity acquisition processing (step S101) is larger than the predetermined initial threshold. Also, the difference between the first previous intensity and the second previous intensity acquired for the one pixel 80 is smaller than the difference between the first previous intensity and the second previous intensity acquired for the one other pixel 80. For example, the difference between the first previous intensity and the second previous intensity for the one pixel 80 is the smallest for the multiple pixels 80. At this time, the intensity of the light 21 of the light source 20 that causes the light 21 to be incident on the incident portion 10a of the light guide 10 of the multiple light guides 10 corresponding to the one other pixel 80 when the one other pixel 80 is in the light-extracting state ST1 is reduced according to the ratio of the difference between the first previous intensity and the second previous intensity for the one pixel 80 to the difference between the first previous intensity and the second previous intensity for the one other pixel 80.

Thereby, the image can be made uniform in the initial state of the display device 110.

### Second Embodiment

In the embodiment, the processing of making the image uniform is performed for multiple tone states.

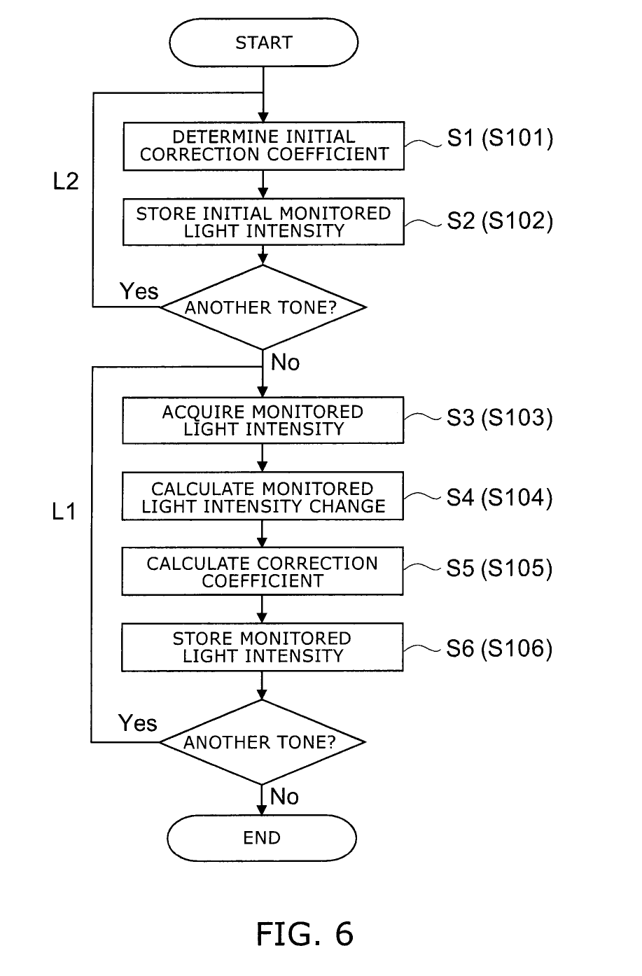

FIG. 6 is a flowchart showing the method for adjusting the display device according to the second embodiment.

As shown in FIG. 6, a first loop L1 that includes step S1 and step S2 is performed in mutually-different multiple tone states. Then, a second loop L2 that includes step S3 to step S6 is multiply performed in the mutually-different multiple tone states. Otherwise, the processing is similar to that described in regard to the first embodiment; and a description is therefore omitted.

For example, in a second tone state that is different from the first tone state, the light 21 is emitted from the multiple light sources 20 to perform a display including at least one selected from a second brightness different from the first brightness and a second color different from the first color.

In the second tone state, second light intensity acquisition processing (another step S103) is implemented. For example, a third intensity of the light propagating to the one other end portion 10b when the pixel 80 is in the light-extracting state ST1 and a fourth intensity of the light propagating to the one other end portion 10b when the pixel 80 is in the non light-extracting state ST2 are acquired for at least two pixels 80 of the multiple pixels 80.

The third intensity recited above is a value that is proportional to the intensity of the light propagating to the one other end portion 10b when the pixel 80 is in the light-extracting state ST1. The fourth intensity recited above is a value that is proportional to the intensity of the light propagating to the one other end portion 10b when the pixel 80 is in the non light-extracting state ST2. The proportionality coefficient of the third intensity is the same as the proportionality coefficient of the fourth intensity. The proportionality coefficients may be 1.

In such a case as well, a third previous intensity of the light propagating to the one other end portion 10b when the pixel 80 is in the light-extracting state ST1 and a fourth previous intensity of the light propagating to the one other end portion 10b when the pixel 80 is in the non light-extracting state ST2 in the second tone state are acquired prior to implementing the second light intensity acquisition processing. For example, these values relating to the second tone state are acquired in step S101 and step S102.

The third previous intensity recited above is a value that is proportional to the intensity of the light propagating to the one other end portion 10b when the pixel 80 is in the light-extracting state ST1. The fourth previous intensity recited above is a value that is proportional to the intensity of the light propagating to the one other end portion 10b when the pixel 80 is in the non light-extracting state ST2. The proportionality coefficient of the third previous intensity is the same as the proportionality coefficient of the fourth previous intensity. The proportionality coefficients may be 1.

Then, in second change amount calculation processing (another step S104), the ratio of the absolute value of the difference between the third intensity and the fourth intensity to the absolute value of the difference between the third previous intensity and the fourth previous intensity in the second tone state acquired prior to the second light intensity acquisition processing is calculated for the at least two pixels.

Continuing, a third value which is the ratio recited above calculated for a third pixel of the at least two pixels 80 is higher than a predetermined second threshold and lower than a fourth value which is the ratio recited above calculated for the fourth pixel of the at least two pixels 80. For example, the third pixel is the darkest pixel 80 of the at least two pixels 80 in the second tone state.

At this time, in the second light intensity modification processing (another step S105), the intensity of the light 21 of the light source 20 that causes the light 21 to be incident on the incident portion 10a of the light guide 10 of the multiple light guides 10 corresponding to the fourth pixel when the fourth pixel is in the light-extracting state ST1 is reduced according to the ratio of the third value to the fourth value.

For example, the ratio of the third value calculated for the third pixel to the fourth value calculated for the fourth pixel is used as the correction coefficient of the fourth pixel in the second tone state. The intensity of the light 21 of the light source 20 corresponding to the fourth pixel after the correction is set to be the value prior to the correction multiplied by the correction coefficient.

For example, the absolute value of the difference between the intensity of the light 21 of the light source 20 that causes the light 21 to be incident on the incident portion 10a of the light guide 10 corresponding to the fourth pixel when the fourth pixel is in the light-extracting state ST1 after implementing the second light intensity modification processing and the value of the intensity of the light of the light source 20 prior to implementing the fourth light intensity modification processing multiplied by the ratio of the third value to the fourth value is caused to be less than the absolute value of the difference between the intensity of the light 21 of the light source 20 prior to implementing the second light intensity modification processing and the value of the intensity of the light 21 of the light source 20 prior to implementing the second light intensity modification processing multiplied by the ratio of the third value to the fourth value.

Thereby, the image can be made uniform in the second tone state.

In the embodiment, the correction coefficients are determined for the multiple tone states. The uniformity of the image is corrected using the correction coefficients of each of the tone states. Thereby, the uniformity increases further. For example, the first loop L1 and the second loop L2 are performed according to the number of the tone states for which the correction coefficients are determined.

The tone state includes the intensity and color of the light. For example, the correction coefficient is determined for the colors of red, green, and blue. For example, there are cases where the degradation of the light sources 20 over time is different between the colors. In such a case, a display having higher uniformity can be performed by determining the correction coefficients respectively for the different colors.

### Third Embodiment

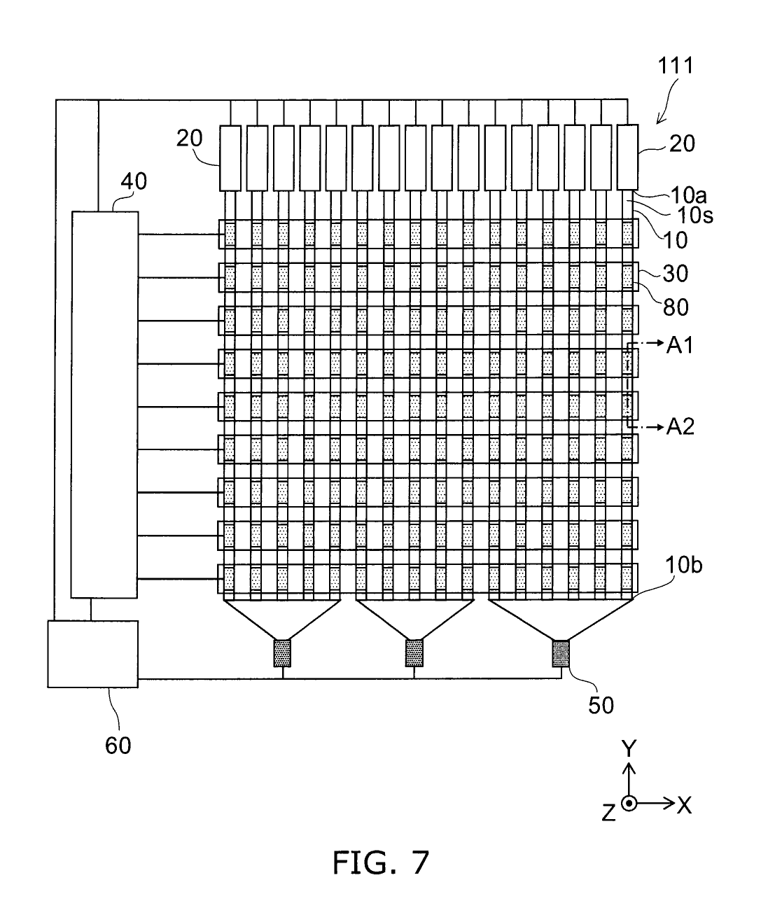

FIG. 7 is a schematic plan view showing a display device according to a third embodiment.

As shown in FIG. 7, one light sensor 50 is provided for multiple light guides 10 in the display device 111 according to the embodiment. Otherwise, the configuration of the display device 111 may be similar to the display device 110; and a description is therefore omitted.

For example, one light sensor senses the first intensity of the light propagating to the one other end portion 10b of one light guide 10 when the pixel 80 is in the light-extracting state ST1 and the second intensity of the light propagating to the one other end portion 10b of the one light guide 10 when the pixel 80 is in the non light-extracting state ST2. The one light sensor further senses the intensity of the light propagating to the one other end portion 10b of one other light guide 10 when the pixel 80 is in the light-extracting state ST1 and the intensity of the light propagating to the one other end portion 10b of the one other light guide 10 when the pixel 80 is in the non light-extracting state ST2.

For example, the multiple light sources 20 are selected sequentially; and the intensity of the light propagating to the one other end portion 10b of the light guide 10 corresponding to the selected light source 20 is sensed by the one light sensor 50. In other words, the monitored light (the light 21f and the light 22f) of the multiple light guides 10 is sensed by the one light sensor 50.

In the embodiment, there are cases where the distance between the light sensor 50 and the light guide 10 is different between the multiple light guides 10. The difference of the distances substantially does not affect the correction processing recited above. In other words, in the correction processing recited above, the processing is performed based on the ratio of the difference between the monitored light (the light 21f) in the light-extracting state ST1 and the monitored light (the light 22f) in the non light-extracting state ST2 (the ratio of the value after changing over time to the value before changing over time). In the embodiment, the changes for these values are relative and therefore substantially do not affect the fluctuation of the intensity of the light incident on the light sensor 50 for each of the light guides 10. In the embodiment, it is sufficient for the ratio of the intensity of the light incident on the light sensor 50 to the light propagating through the light guide 10 to be maintained.

In the embodiment, the number of the light sensors 50 can be reduced; and the device can be simplified.

### Fourth Embodiment

The embodiment relates to a display device. The display device according to the embodiment includes, for example, the display device 110, the display device 111, or a display device of a modification of the display device 110 or 111. In the display device according to the embodiment, the methods for adjusting the display device described in regard to the first to third embodiments are implementable.

The display device according to the embodiment includes the multiple light sources 20, the multiple light guides 10, the multiple light extraction units 30, the controller 40, the light sensor 50, and the memory unit 60.

The configurations described in regard to the embodiments recited above are applied to the multiple light sources 20, the multiple light guides 10, and the multiple light extraction units 30.

The light sensor 50 senses the intensity of the light that reach the one other end portion 10b of each of the multiple light guides 10. As described above, the intensity sensed by the light sensor 50 may be an intensity that is proportional to the intensity of the light that reaches the one other end portion 10b.

The memory unit 60 stores at least the first previous intensity of the light propagating to the one other end portion 10b when the pixel 80 is in the light-extracting state ST1 and the second previous intensity of the light propagating to the one other end portion 10b when the pixel 80 is in the non light-extracting state ST2 in the first tone state of emitting the light 21 from the multiple light sources 20 to perform the display of the first brightness and the first color.

The controller 40 causes the multiple light extraction units 30 to form the light-extracting state ST1 and the non light-extracting state ST2 by supplying an electrical signal to the multiple light extraction units 30. The controller 40 further implements the first light intensity acquisition processing, the first change amount calculation processing, and the first light intensity modification processing recited below.

In the first light intensity acquisition processing, the controller 40 causes the light sensor 50 to sense the first intensity of the light propagating to the one other end portion 10b when the pixel 80 is in the light-extracting state ST1 and the second intensity of the light propagating to the one other end portion 10b when the pixel 80 is in the non light-extracting state ST2 for at least two pixels 80 of the multiple pixels 80 in the first tone state. Thereby, the first intensity and the second intensity are acquired.

In the first change amount calculation processing, the controller 40 calculates the ratio of the absolute value of the difference between the first intensity and the second intensity to the absolute value of the difference between the first previous intensity and the second previous intensity stored in the memory unit 60 for the at least two pixels 80.

In the first light intensity modification processing, the controller 40 determines the first value and the second value recited below. The first value which is the ratio recited above calculated for the first pixel of the at least two pixels 80 is higher than the predetermined first threshold. The first value is lower than the second value which is the ratio recited above calculated for the second pixel of the at least two pixels 80.

At this time, in the first light intensity modification processing, the controller 40 reduces, according to the ratio of the first value to the second value, the intensity of the light 21 of the light source 20 that causes the light 21 to be incident on the incident portion 10a of the light guide 10 of the multiple light guides 10 corresponding to the second pixel when the second pixel is in the light-extracting state ST1.

In other words, the controller 40 controls the light source 20 such that the intensity when the second pixel is in the light-extracting state ST1 decreases according to the ratio of the first value to the second value. For example, the controller 40 performs the processing described in regard to step S103 to step S105 recited above.

According to the embodiment, a display device for which a uniform image is possible can be provided.

For example, the controller 40 may implement the methods for adjusting the display device described in regard to the first to third embodiments.

In the embodiment, the controller 40 may further implement the first post-modification light intensity storage processing (step S106). For example, the controller 40 replaces the first previous intensity recited above in the memory unit 60 with the intensity of the light 21 of the light source 20 that causes the light 21 to be incident on the incident portion 10a of the light guide 10 corresponding to the second pixel when the second pixel is in the light-extracting state ST1 after the first light intensity modification processing. Further, the controller 40 replaces the second previous intensity in the memory unit 60 with the intensity of the light 21 of the light source 20 that causes the light 21 to be incident on the incident portion 10a of the light guide 10 corresponding to the second pixel when the second pixel is in the non light-extracting state ST2 after the first light intensity modification processing.

The controller 40 may further implement step S103 to step S105 using the new first previous intensity and the new second previous intensity that are substituted.

The controller 40 may implement the first initial light intensity acquisition processing (step S101) and the first initial light intensity modification processing (step S102) as the initial adjustment processing.

The controller 40 may perform the correction processing recited above in the second tone state which is different from the first tone state.

In the embodiment, the light sensor 50 may sense the intensity of the light propagating to the one other end portion 10b of the light guide 10 for multiple light sources 20. In other words, the light sensor 50 may sense the monitored light intensity for multiple light guides 10.

In the display device and the method for adjusting the display device (the method for correcting the image unevenness) according to the embodiments, a portion of the light that propagates through the light guide 10 and does not contribute to the image is extracted (the monitored light intensity acquisition step of step S3) for the pixel 80 in the light-extracting state ST1 and the non light-extracting state ST2 for any tone.

The monitored light intensity change is calculated (the monitored light intensity change calculation step of step S4) to determine the ratio of the difference between the monitored light intensities in the extraction state ST1 and the non-extracting state ST2 obtained in the subsequent monitored light intensity acquisition step to the difference between the monitored light intensities obtained in the monitored light intensity storage step.

Further, new correction coefficients are obtained (the correction coefficient update step of step S5) by dividing the minimum value of the ratio of the difference between the monitored light intensities for all of the pixels 80 obtained in the monitored light intensity change calculation step by the minimum value of the difference between the monitored light intensities for each of the pixels 80 and multiplying these values by pre-set correction coefficients for each of the pixels to reduce the tone for each of the light sources 20.

The monitored light intensities for the pixel 80 in the light-extracting state ST1 and the non light-extracting state ST2 when each of the light sources 20 displays the tone multiplied by the new correction coefficients are stored in the memory unit 60 (the monitored light intensity storage step of step S6).

Further, the determination of the initial values of the correction coefficients (the initial correction coefficient determination step of step S1) may be implemented for each of the pixels 80 in the state in which the light sources 20 are set to any tone to reduce the tone of the light sources 20 by measuring the brightness of all of the pixels 80 and causing the brightness of the other pixels 80 to match the brightness of the darkest pixel 80.

Also, the storage in the memory unit 60 of the initial values of the monitored light intensities for the pixel 80 in the light-extracting state ST1 and the non light-extracting state ST2 (the initial monitored light intensity storage step of step S2) may be implemented when each of the light sources 20 is caused to display the tone for the multiplied correction coefficients.

For example, the monitored light intensity acquisition step recited above may be implemented outside the image display period. For example, the monitored light intensity and the correction coefficient may be measured and calculated for multiple tones. For example, the monitored light intensity and the correction coefficient may be measured and calculated for multiple colors.

A threshold may be set for the ratio of the difference of the monitored light amounts recited above; and the pixel may be excluded from the correction processing recited above when the ratio of the difference is not more than the threshold. A threshold may be set for the difference of the monitored light amounts recited above; and the pixel may be excluded from the correction processing recited above when the difference is not more than the threshold.

According to the embodiments, a display device and a method for adjusting the display device for which a uniform image is possible can be provided. According to the embodiments, a display device and a method for adjusting the display device for which the image unevenness due to the change over time is reduced are provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the display device such as the light source, the light guide, the light extraction unit, the controller, the light sensor, the memory unit, etc., from known art; and such practice is within the scope of the invention to the extent that similar effects are obtained.

Further, any two or more components of the specific examples may be combined within the extent of technical feasibility and are included in the scope of the invention to the extent that the purport of the invention is included.

Moreover, all display devices and methods for adjusting display devices practicable by an appropriate design modification by one skilled in the art based on the display devices and the methods for adjusting display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A method for adjusting a display device,
the device including:
a plurality of light sources to emit light;
a plurality of light guides, each of light guides including an incident portion, an other end portion provided on a side opposite to the incident portion, and a side surface extending along a first direction from the incident portion toward the other end portion, the light guides being arranged along a second direction intersecting the first direction;
a plurality of light extraction units arranged along the first direction to oppose the side surface of each of the light guides, each of the light extraction units extending along the second direction and being configured to form each of a plurality of pixels at each of a plurality of portions where the light extraction units and the side surface of the light guides oppose each other; and
a controller configured to supply an electrical signal to the light extraction units to cause the light extraction units to form a light-extracting state and a non light-extracting state in accordance with the electrical signal, the light propagating through the light guides being extracted from the pixels in the light-extracting state, an intensity of the extracted light in the non light-extracting state being lower than an intensity of the extracted light in the light-extracting state,
the method comprising:
performing a first light intensity acquisition processing to acquire a first intensity and a second intensity for at least two pixels of the pixels in a first tone state of emitting the light from the light sources to perform a display having a first brightness and a first color, the first intensity being an intensity of the light propagating to the other end portion when the pixels being in the light-extracting state, the second intensity being an intensity of the light propagating to the other end portion when the pixels being in the non light-extracting state, the at least two pixels including a first pixel and a second pixel;
performing a first change amount calculation processing to calculate a ratio of a first present absolute value of a difference between the first intensity and the second intensity to a first previous absolute value of a difference between a first previous intensity and a second previous intensity for the at least two pixels in the first tone state, the first previous intensity being an intensity of the light propagating to the other end portion when the pixels being in the light-extracting state, the second previous intensity being an intensity of the light propagating to the other end portion when the pixels being in the non light-extracting state, the first previous intensity and the second previous intensity being acquired prior to the first light intensity acquisition processing, the first change amount calculation processing including obtaining a first value being the calculated ratio for the first pixel and a second value being the calculated ratio for the second pixel; and
performing a first light intensity modification processing to reduce a modifying intensity in accordance with a ratio of the first value to the second value when the first value is higher than a first threshold and lower than the second value, the first threshold being predetermined, the modifying intensity being an intensity of the light of one of the light sources to cause the light to be incident on the incident portion of one of the light guides corresponding to the second pixel when the second pixel being in the light-extracting state.

2. The method according to claim 1, wherein the first light intensity modification processing includes making a first absolute value of a first difference to be less than a second absolute value of a second difference,
the first difference is a difference between
the intensity of the light of one the light sources configured to cause the light to be incident on the incident portion of one of the light guides corresponding to the second pixel when the second pixel is in the light-extracting state after the performing the first light intensity modification processing and
a prior value of the ratio of the first value to the second value multiplied by the intensity of the light of one of the light sources configured to cause the light to be incident on the incident portion of one of the light guides corresponding to the second pixel when the second pixel is in the light-extracting state prior to the performing the first light intensity modification processing,
the second difference is a difference between
the intensity of the light of one of the light sources configured to cause the light to be incident on the incident portion of one of the light guides corresponding to the second pixel when the second pixel is in the light-extracting state prior to the performing the first light intensity modification processing and
the prior value.

3. The method according to claim 1, wherein the first light intensity modification processing includes making a after intensity to be a value of the ratio of the first value to the second value multiplied by the intensity of the light of one of the light sources configured to cause the light to be incident on the incident portion of one of the light guides corresponding to the second pixel when the second pixel is in the light-extracting state prior to the performing the first light intensity modification processing, and
the after intensity is the intensity of the light of one the light sources configured to cause the light to be incident on the incident portion of one of the light guides corresponding to the second pixel when the second pixel is in the light-extracting state after the performing the first light intensity modification processing.

4. The method according to claim 1, further comprising performing a first post-modification light intensity storage processing to store the intensity of the light of one of the light sources configured to cause the light to be incident on the incident portion of one of the light guides corresponding to the second pixel when the second pixel is in the light-extracting state after being reduced in the first light intensity modification processing.

5. The method according to claim 1, further comprising performing a corrected value substitution processing including:
replacing the first previous intensity with the intensity of the light of one of the light sources configured to cause the light to be incident on the incident portion of one of the light guides corresponding to the second pixel when the second pixel is in the light-extracting state after the first light intensity modification processing; and
replacing the second previous intensity with the intensity of the light of one of the light sources configured to cause the light to be incident on the incident portion of one of the light guides corresponding to the second pixel when the second pixel is in the non light-extracting state after the first light intensity modification processing.

6. The method according to claim 1, further comprising:
performing a second light intensity acquisition processing to acquire a third intensity and a fourth intensity for at least two pixels of the plurality of pixels including a third pixel and a fourth pixel in a second tone state of emitting the light from the light sources to perform a display having at least one selected from a second brightness and a second color, the second brightness being different from the first brightness, the second color being different from the first color, the third intensity being an intensity of the light propagating to the other end portion when the pixels being in the light-extracting state, the fourth intensity being an intensity of the light propagating to the other end portion when the pixels being in the non light-extracting state;
performing a second change amount calculation processing to calculate a ratio of a second present absolute value of a difference between the third intensity and the fourth intensity to a second previous absolute value of a difference between a third previous intensity and a fourth previous intensity for the at least two pixels in the second tone state, the third previous intensity being an intensity of the light propagating to the other end portion when the pixel being in the light-extracting state, the fourth previous intensity being an intensity of the light propagating to the other end portion when the pixels being in the non light-extracting state, the third previous intensity and the fourth previous intensity being acquired prior to the second light intensity acquisition processing, the second change amount calculation processing including obtaining a third value being the calculated ratio for the third pixel and a fourth value being the calculated ratio for the fourth pixel; and
performing a second light intensity modification processing to reduce an intensity of the light of one of the light sources to cause the light to be incident on the incident portion of one of the light guides corresponding to the fourth pixel when the fourth pixel being in the light-extracting state in accordance with a ratio of the third value to the fourth value, when the third value being higher than a second threshold and lower than the fourth value, the second threshold being predetermined.

7. The method according to claim 1, wherein
the display device includes a display period of an image display operation performed using the plurality of pixels, and
at least a portion of the first light intensity acquisition processing, the first change amount calculation processing, and the first light intensity modification processing is performed in a period different from the display period.

8. The method according to claim 1, further comprising:
performing a first initial light intensity acquisition processing to acquire the first previous intensity and the second previous intensity, the pixels including a fifth pixel and a sixth pixel; and
performing a first initial light intensity modification processing to reduce an initial intensity in accordance with an initial ratio when a first initial difference is larger than an initial threshold and smaller than a second initial difference, the initial threshold being predetermined,
the first initial difference being a difference between the first previous intensity and the second previous intensity acquired for the fifth pixel in the first initial light intensity acquisition processing,
the second initial difference being a difference between the first previous intensity and the second previous intensity acquired for the sixth pixel in the first initial light intensity acquisition processing,
the initial intensity being an intensity of the light of one of the light sources to cause the light to be incident on the incident portion of one of the light guides corresponding to the sixth pixel when the sixth pixel being in the light-extracting state.

9. The method according to claim 1, wherein the first light intensity modification processing is not performed when the first value is not more than the first threshold.

10. The method according to claim 1, wherein the first light intensity acquisition processing, the first change amount calculation processing, and the first light intensity modification processing are performed at a predetermined interval.

11. The method according to claim 1, wherein the first light intensity acquisition processing, the first change amount calculation processing, and the first light intensity modification processing are performed before a display operation is started.

12. The method according to claim 1, wherein the first light intensity acquisition processing, the first change amount calculation processing, and the first light intensity modification processing are performed after a display operation ends.

13. A display device, comprising:
a plurality of light sources to emit light;
a plurality of light guides, each of light guides including an incident portion, an other end portion provided on a side opposite to the incident portion, and a side surface extending along a first direction from the incident portion toward the other end portion, the light being incident on the incident portion, the light guides being configured to allow the light to propagate from the incident portion toward the other end portion, the light guides being arranged along a second direction intersecting the first direction;
a plurality of light extraction units arranged along the first direction to oppose the side surface of each of the light guides, each of the light extraction units extending along the second direction and being configured to form each of a plurality of pixels at each of a plurality of portions where the light extraction units and the side surface of the light guides oppose each other; and
a controller configured to supply an electrical signal to the light extraction units to cause the light extraction units to form a light-extracting state and a non light-extracting state in accordance with the electrical signal, the light propagating through the light guides being extracted from the pixels in the light-extracting state, an intensity of the extracted light in the non light-extracting state being lower than an intensity of the extracted light in the light-extracting state;
a light sensor configured to sense the intensity of the light reaching the other end portion of the light guides; and
a memory unit configured to store a first previous intensity and a second previous intensity in a first tone state of emitting the light from the light sources to perform a display having a first brightness and a first color, the first previous intensity being an intensity of the light propagating to the other end portion when the pixels being in the light-extracting state, the second previous intensity being an intensity of the light propagating to the other end portion when the pixels being in the non light-extracting state,
the controller being configured
to perform a first light intensity acquisition processing to acquire a first intensity and a second intensity for at least two pixels of the pixels in the first tone state, the first intensity being an intensity of the light propagating to the other end portion when the pixels being in the light-extracting state, the second intensity being an intensity of the light propagating to the other end portion when the pixels being in the non light-extracting state, the at least two pixels including a first pixel and a second pixel;
to perform a first change amount calculation processing to calculate a ratio of a first present absolute value of a difference between the first intensity and the second intensity to a first previous absolute value of a difference between the first previous intensity and a second previous intensity for the at least two pixels in the first tone state, the first previous intensity and the second previous intensity being stored in the memory unit, the first change amount calculation processing including obtaining a first value being the calculated ratio for the first pixel and a second value being the calculated ratio for the second pixel; and
to perform a first light intensity modification processing to reduce a modifying intensity in accordance with a ratio of the first value to the second value when the first value is higher than a first threshold and lower than the second value, the first threshold being predetermined, the modifying intensity being an intensity of the light of one of the light sources to cause the light to be incident on the incident portion of one of the light guides corresponding to the second pixel when the second pixel being in the light-extracting state.

14. The device according to claim 13, wherein the first light intensity modification processing includes making a first absolute value of a first difference to be less than a second absolute value of a second difference,
the first difference is a difference between
the intensity of the light of one the light sources configured to cause the light to be incident on the incident portion of one of the light guides corresponding to the second pixel when the second pixel is in the light-extracting state after the performing the first light intensity modification processing and
a prior value of the ratio of the first value to the second value multiplied by the intensity of the light of one of the light sources configured to cause the light to be incident on the incident portion of one of the light guides corresponding to the second pixel when the second pixel is in the light-extracting state prior to the performing the first light intensity modification processing,
the second difference is a difference between
the intensity of the light of one of the light sources configured to cause the light to be incident on the incident portion of one of the light guides corresponding to the second pixel when the second pixel is in the light-extracting state prior to the performing the first light intensity modification processing and
the prior value.

15. The device according to claim 13, wherein the first light intensity modification processing includes making a after intensity to be a value of the ratio of the first value to the second value multiplied by the intensity of the light of one of the light sources configured to cause the light to be incident on the incident portion of one of the light guides corresponding to the second pixel when the second pixel is in the light-extracting state prior to the performing the first light intensity modification processing, and
the after intensity is the intensity of the light of one the light sources configured to cause the light to be incident on the incident portion of one of the light guides corresponding to the second pixel when the second pixel is in the light-extracting state after the performing the first light intensity modification processing.

16. The device according to claim 13, wherein the controller is configured to further perform a first post-modification light intensity storage processing to store the intensity of the light of one of the light sources configured to cause the light to be incident on the incident portion of one of the light guides corresponding to the second pixel when the second pixel is in the light-extracting state after being reduced in the first light intensity modification processing.

17. The device according to claim 13, wherein the controller is configured to further perform a corrected value substitution processing including:
replacing the first previous intensity with the intensity of the light of one of the light sources configured to cause the light to be incident on the incident portion of one of the light guides corresponding to the second pixel when the second pixel is in the light-extracting state after the first light intensity modification processing; and
replacing the second previous intensity with the intensity of the light of one of the light sources configured to cause the light to be incident on the incident portion of one of the light guides corresponding to the second pixel when the second pixel is in the non light-extracting state after the first light intensity modification processing.

18. The device according to claim 13, wherein the controller is further configured
to perform a second light intensity acquisition processing to acquire a third intensity and a fourth intensity for at least two pixels of the plurality of pixels including a third pixel and a fourth pixel in a second tone state of emitting the light from the light sources to perform a display having at least one selected from a second brightness and a second color, the second brightness being different from the first brightness, the second color being different from the first color, the third intensity being an intensity of the light propagating to the other end portion when the pixels being in the light-extracting state, the fourth intensity being an intensity of the light propagating to the other end portion when the pixels being in the non light-extracting state;
to perform a second change amount calculation processing to calculate a ratio of a second present absolute value of a difference between the third intensity and the fourth intensity to a second previous absolute value of a difference between a third previous intensity and a fourth previous intensity for the at least two pixels in the second tone state, the third previous intensity being an intensity of the light propagating to the other end portion when the pixel being in the light-extracting state, the fourth previous intensity being an intensity of the light propagating to the other end portion when the pixels being in the non light-extracting state, the third previous intensity and the fourth previous intensity being acquired prior to the second light intensity acquisition processing, the second change amount calculation processing including obtaining a third value being the calculated ratio for the third pixel and a fourth value being the calculated ratio for the fourth pixel; and
to perform a second light intensity modification processing to reduce an intensity of the light of one of the light sources to cause the light to be incident on the incident portion of one of the light guides corresponding to the fourth pixel when the fourth pixel being in the light-extracting state in accordance with a ratio of the third value to the fourth value, when the third value being higher than a second threshold and lower than the fourth value, the second threshold being predetermined.

19. The device according to claim 13, wherein
the display device includes a display period of an image display operation performed using the plurality of pixels, and
at least a portion of the first light intensity acquisition processing, the first change amount calculation processing, and the first light intensity modification processing is performed in a period different from the display period.

20. The device according to claim 13, wherein the controller is further configured
to perform a first initial light intensity acquisition processing to acquire the first previous intensity and the second previous intensity, the pixels including a fifth pixel and a sixth pixel; and
to perform a first initial light intensity modification processing to reduce an initial intensity in accordance with an initial ratio when a first initial difference is larger than an initial threshold and smaller than a second initial difference, the initial threshold being predetermined,
the first initial difference being a difference between the first previous intensity and the second previous intensity acquired for the fifth pixel in the first initial light intensity acquisition processing,
the second initial difference being a difference between the first previous intensity and the second previous intensity acquired for the sixth pixel in the first initial light intensity acquisition processing,
the initial intensity being an intensity of the light of one of the light sources to cause the light to be incident on the incident portion of one of the light guides corresponding to the sixth pixel when the sixth pixel being in the light-extracting state.
